(19) United States
(12) Patent Application Publication
(10) Pub. No.: US 2026/0131452 A1
(43) Pub. Date: May 14, 2026

(54) WORKING ROBOT

(71) Applicant: SHENZHEN HANYANG TECHNOLOGY CO., LTD., Shenzhen (CN)

(72) Inventors: Yang Huang, Shenzhen (CN); Taotao Zhu, Shenzhen (CN); Yongqi Song, Shenzhen (CN); Haitao Li

(21) Appl. No.: 19/444,516

(22) Filed: Jan. 9, 2026

Related U.S. Application Data
(63) Continuation of application No. 19/004,233, filed on Dec. 28, 2024.
Application No. 19/004,233 is a continuation of application No. PCT/CN2023/126266, filed on Oct. 24, 2023.

(30) Foreign Application Priority Data
Jun. 16, 2023 (CN) 202310724634.0
Jun. 16, 2023 (CN) 202321557190.8

(51) Int. Cl. B25J 5/00; B25J 9/10; B25J 9/12; B25J 11/00

(52) U.S. Cl. CPC B25J 5/007; B25J 9/106; B25J 9/123; B25J 11/008

(57) ABSTRACT

Provided is a working robot (1000), including an actuator mechanism (110) and a mobile robot (200). The mobile robot (200) further includes a robot body (10), a bracket (20) and a pushing mechanism (30). The bracket (20) is installed on the robot body (10) in a pitchable and rotatable manner, and actuator mechanism (110) is detachably installed on the bracket (20). The pushing mechanism (30) is installed in the robot body (10), and drivingly connected with the bracket (20) to drive the bracket (20) to rotate, so as to drive the actuator mechanism (110) to pitch up and down relative to the mobile robot (200).

### CROSS-REFERENCE TO RELATED APPLICATION(S)

The present application is a Continuation Application U.S. application Ser. No. 19/004,233 filed on Dec. 28, 2024, which is a Continuation Application of PCT Application No. PCT/CN2023/126266 filed on Oct. 24, 2023, which claims priority to Chinese Invention Patent Application No. 202310724634.0, filed on Jun. 16, 2023, titled “Multifunctional robot”, and Chinese Utility Model Patent Application No. 202321557190.8, filed on Jun. 16, 2023, titled “Lifting device and robot with the same”, the contents of which are incorporated herein by reference in their entirety.

### TECHNICAL FIELD

The application relates to the technical field of intelligent working equipment, in particular to a working robot.

### BACKGROUND

Nowadays, working robots are commonly used in place of manual labor to alleviate physical labor and enhance people's lives. A working robot typically consists of a mobile body and an actuator device assembled on the mobile body, and the actuator device is driven by the mobile body to work in a predetermined area. However, the current actuator device is generally fixed, making it impossible to fulfill users' diverse needs.

### SUMMARY

The main purpose of this application is to propose a working robot, aiming at addressing the technical problem that the working robot's fixed actuator mechanism makes it challenging to meet the diversified demand of users.

In order to achieve the above purpose, the embodiment of the application proposes a working robot, including an actuator mechanism and a mobile robot. The mobile robot a includes robot body, a bracket and a pushing mechanism. The bracket is installed on the robot body in a pitchable and rotatable manner, and actuator mechanism is detachably installed on the bracket. The pushing mechanism is installed in the robot body, and drivingly connected with the bracket to drive the bracket to rotate, so as to drive the actuator mechanism to pitch up and down relative to the mobile robot.

According to the embodiments of the application, a bracket fixed with the actuator mechanism is installed on the robot body of the mobile robot, the actuator mechanism is detachably installed on the bracket, and the bracket is assembled at the robot body in a pitchable and rotatable manner, the pushing mechanism is assembled inside the robot body to reduce the overall size of the mobile robot and increase integration. The pushing mechanism drives the bracket to pitch up and down, thus driving the actuator mechanism to pitch up and down.

In the working process of the working robot, the mobile robot can control the pitch motion of the actuator mechanism according to different situations. For example, when encountering obstacles, it can control the actuator mechanism to pitch up to cross the obstacles rather than moving around them. For example, when the working target is located at different heights and angles, the mobile robot can control the pitch motion of the actuator mechanism, so as to work on the working target at different heights and angles. For example, when replacing the actuator mechanism, the mobile robot controls the pitch motion of the actuator mechanism, allowing it to move to the height and angle that is most suitable for the user to replace, meeting the user's diverse needs.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. For those of ordinary skill in this field, other drawings may be obtained according to these drawings without any creative effort.

FIG. 1 is a schematic diagram of the disassembly structure of a working robot provided by an embodiment of the present application.

FIG. 2 is a structural schematic diagram of the mobile robot of the working robot of FIG. 1 from a perspective (the pushing mechanism is in an extended limit state).

FIG. 3 is a schematic structural diagram of the mobile robot of the working robot of FIG. 1 from another perspective (the pushing mechanism is in a retraction limit state).

FIG. 4 is a side view of the mobile robot of the working robot of FIG. 1 when the electric push rod is extended to the limit position.

FIG. 5 shows a partial enlarged view of the installation part of the mobile robot of FIG. 4.

FIG. 6 shows a partial structural schematic diagram of the actuator mechanism of the working robot of FIG. 1.

FIG. 7 shows an enlarged structural diagram of the actuator mechanism at A in FIG. 6.

Reference signs in the drawings are as follows.

10. Robot body; 11. Side plate; 12. Support beam; 13. Back connecting plate; 14. Bottom plate; 15. Third rotating shaft; 20. Bracket; 21. Column; 22. Installation part; 30. Pushing mechanism; 40. Linkage mechanism; 41. First connecting rod; 4121. Loop plate; 42. Second connecting rod; 43. First rotating shaft; 44. Second rotating shaft; 200. Mobile robot; 110. Actuator mechanism; 311. Clamping groove; 312. Insertion column; 321. Insertion hole; 322. Buckle; 31. Output end; 16. Housing; 111. Through hole; 411. First end of the first connecting rod; 412. Second end of the first connecting rod; 421. First end of the second connecting rod; 422. Second end of the second connecting rod; 23. First connection end; 24. Second connection end; 211. First limit surface; 212. Second limit surface; 1000. Working robot.

### DETAILED DESCRIPTION

In order to provide a better understanding for those skilled in the art, the technical solutions in the embodiments of the present application will be clearly and completely described below with reference to the drawings in the embodiments of this application. Obviously, the described embodiments are merely part of the embodiments of this application, not all of them. Based on the embodiments in this application, all other embodiments obtained by those of ordinary skill in the art without creative effort belong to the protection scope of this application.

Working robots replace manual operation with intelligent operation, improving people's lives and allowing for the release of labor.

A working robot typically consists of a mobile body and an actuator device assembled on the mobile body, and the actuator device is driven by the mobile body to work in a predetermined area. However, the current actuator device is generally fixed, making it impossible to fulfill users' diverse needs.

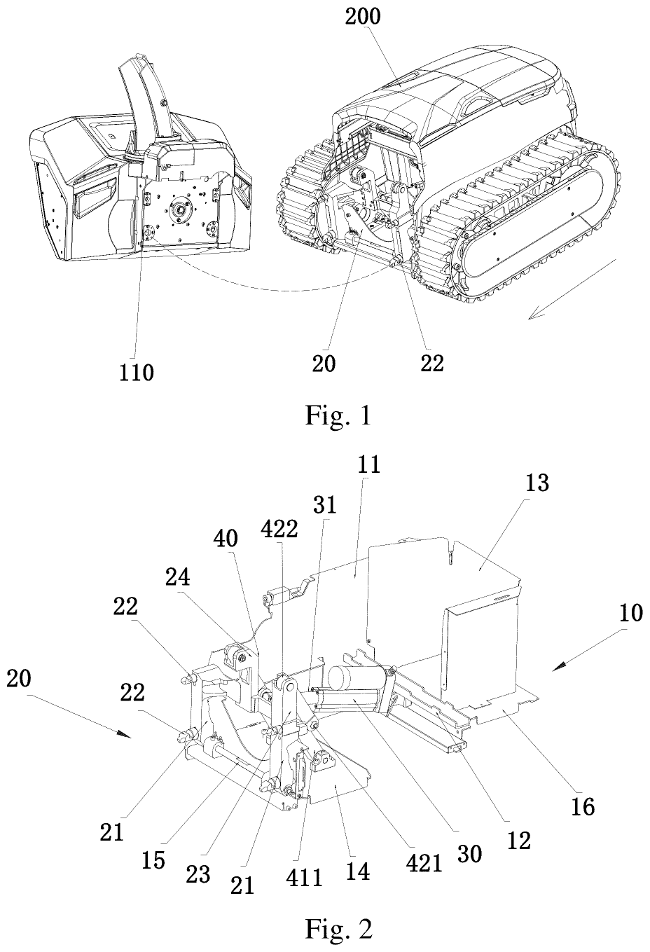

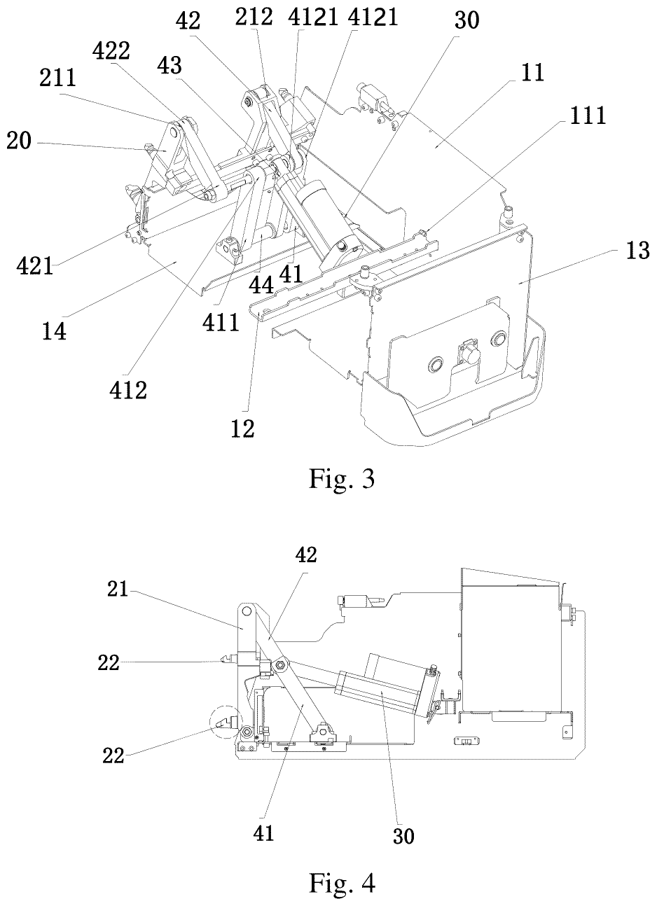

Referring to FIG. 1 to FIG. 3, the embodiment of the application proposes a working robot 1000, which includes an actuator mechanism 110 and a mobile robot 200. The mobile robot 200 includes a robot body 10, a bracket 20 and a pushing mechanism 30. The actuator mechanism 110 is detachably installed on the bracket, the pushing mechanism 30 can drive the bracket 20 to pitch up and down relative to the robot body 10, causing the actuator mechanism 110 fixed on the bracket 20 to pitch up and down relative to the mobile robot 200. This realizes obstacle avoidance and allows for operating at various heights and angles to accommodate the diverse needs of users.

As the actuator mechanism 110 is detachably installed on the bracket 20, it is convenient to maintain and repair the actuator mechanism 110 or/and the mobile robot, and to replace the actuator mechanism 110 with different functions. In addition, because the actuator mechanism 110 and the bracket 20 are detachable, the same bracket 20 can be adapted to the actuator mechanism 110 with different working mechanisms, thus making the working robot 1000 suitable for different use scenarios.

In the following, taking the working robot 1000 applied to yard work as an example, the mobile robot 200 of the working robot 1000 of this application will be explained in detail.

The robot body 10 may include a moving mechanism, and the moving mechanism may be a crawler walking mechanism in the prior art, or a moving chassis with rollers in the prior art, as long as it can move on the ground in different environments, there is no limitation here.

The bracket 20 is mainly used to fix the actuator mechanism 110, allowing for the assembly of the actuator mechanism 110 and the robot body 10, while also providing for actuator mechanism 110.

The pitch motion of the bracket 20 on the robot body 10 is mainly driven by the pushing mechanism 30, which is installed inside the robot body 10 to improve the integration of the mobile robot 200, decrease occupied space, and lower the total size of the mobile robot 200.

The pushing mechanism 30 is drivingly connected with the bracket 20 to drive the bracket 20 to rotate, thereby driving the actuator mechanism 110 to pitch up and down.

It should be noted that the mobile body can be built with a Bluetooth module, a wifi module, or an RTK module, etc., allowing it to move in a predetermined area along a predetermined route, and in some embodiments, drive the actuator device to work.

The pushing mechanism 30 may be a linear driving mechanism, which has simple and reliable driving mode and low cost.

In some embodiments, the robot body 10 of the mobile robot 200 is provided with a bracket 20 which can be fixed with the actuator mechanism 110, and the bracket 20 is assembled at the robot body in a pitchable and rotatable manner, the pushing mechanism 30 is assembled inside the robot body 10 to reduce the overall size of the mobile robot 200 and increase integration. The pushing mechanism 30 drives the bracket 20 to pitch up and down, thus driving the actuator mechanism 110 to pitch up and down.

In the working process of the working robot 1000, the mobile robot 200 can control the pitch motion of the actuator mechanism 110 according to different situations. For example, when encountering obstacles, the mobile robot 200 can control the actuator mechanism 110 to pitch up to cross the obstacles rather than moving around them. For example, when the working target is located at different heights and angles, the mobile robot 200 can control the pitch motion of the actuator mechanism 110, so as to work on the working target at different heights and angles. For example, when replacing the actuator mechanism 110, the mobile robot 200 controls the pitch motion of the actuator mechanism 110, allowing it to move to the height and angle that is most suitable for the user to replace, meeting the user's diverse needs.

The pushing mechanism 30 may be a linear drive element, specifically, an electric push rod is adopted, which is rotatably installed on the robot body 10, and the output end 31 of the electric push rod is drivingly connected to the bracket 20. Apparently, in other embodiments, the pushing mechanism 30 may be other linear drive element mechanisms, such as air cylinders, hydraulic cylinders, linear motors and linear electric cylinders.

In some embodiments, the robot body 10 includes a housing 16 and a support beam 12; the housing 16 has two side plates 11 arranged oppositely, the two side plates 11 are both provided with through holes 111, the support beam 12 penetrates through the through hole 111 on both sides to penetrate the two side plates 11, and the pushing mechanism 30 is installed on the support beam 12.

Specifically, the housing 16 may further include a back connecting plate 13, and two side plates 11 are connected to the opposite sides of the back connecting plate 13 to enclose and connect together.

The support beam 12 penetrates through the two side plates 11 and extends out of the two side plates 11 to be erected on the housing 16, so that the support beam 12 has high structural strength and enhances the fixed stability of the housing 16, and its bearing is borne by the housing 16, further ensuring the installation stability of the pushing mechanism 30 installed on the support beam 12.

In some embodiments, the support beam 12 can be positioned between the top and bottom of the housing 16, making it higher than the bottom of the side plate 11. Thus, while designing the course of the pushing mechanism 30, the course setting can be made shorter in order to improve driving stability when it drives the bracket 20 to move.

Apparently, when the pushing mechanism 30 drives the bracket 20 to pitch up and down, the load of the actuator mechanism 110 is at least partially borne by the pushing mechanism 30. The pushing mechanism 30 can be installed in the middle of the support beam 12, its driving end can be drivingly connected with the middle part of the bracket 20, so that the pushing mechanism 30 can provide sufficient and stable driving performance and supporting performance for the bracket 20 to a great extent, and the supporting strength and driving force of the bracket 20 can be uniformly distributed.

The pushing mechanism 30 is rotatably installed on the support beam 12. Specifically, a rotating shaft is installed on the lower side of the support beam 12, and the pushing mechanism 30 is installed on the rotating shaft, so that it can rotate relative to the support beam 12 and improve its flexibility while driving the bracket 20.

In order to further improve the flexibility of the pushing mechanism 30 to drive the bracket 20 and reduce the course of the pushing mechanism 30 to ensure its driving stability, the mobile robot 200 further includes a linkage mechanism 40 positioned between the pushing mechanism 30 and the bracket 20, and the pushing mechanism 30 is drivingly connected with the bracket 20 through the linkage mechanism 40.

In this way, the pushing mechanism 30 does not need to be directly connected with the bracket 20, and the flexibility of the linkage mechanism 40 can effectively reduce the design complexity of the driving mechanism for driving the bracket 20 to pitch up and down, and the linear motion of the pushing mechanism 30 can be converted into the circular motion of the bracket 20. This allows the driving mechanism simply to be designed as pushing mechanism 30 (electric push rod), which has the advantages of simple structure, stable transmission and low cost.

Specifically, the linkage mechanism 40 includes a first connecting rod 41 and a second connecting rod 42.

A first end 411 of the first connecting rod 41 is rotatably installed on a bottom plate 14 of the robot body 10, and a second end 412 of the first connecting rod 41 is rotatably connected with the output end 31; and a first end 421 of the second connecting rod 42 is rotatably installed on the output end 31 of the linear drive element, and a second end 422 of the second connecting rod 42 is rotatably connected with the bracket 20.

In order to facilitate the installation of the linkage mechanism 40, the linkage mechanism 40 further includes a first rotating shaft 43 rotatably installed on the output end 31 of the electric push rod, the second end 412 of the first connecting rod 41 is rotatably connected with the first rotating shaft 43, and the first end 421 of the second connecting rod 42 is rotatably connected with the first rotating shaft 43.

In this way, the electric push rod drives the first rotating shaft 43 to move, so as to drive the first connecting rod 41 and the second connecting rod 42 to move, thereby driving the pitch motion of the bracket 20.

In order to facilitate the installation of the first connecting rod 41, the linkage mechanism 40 further includes a second rotating shaft 44 rotatably installed on the bottom plate 14 of the robot body 10, and the first end 411 of the first connecting rod 41 is rotatably connected with the second rotating shaft 44.

In some embodiments, in order to improve the transmission stability from the linkage mechanism 40 to transmission bracket 20, the bracket 20 has a first connection end 23 and a second connection end 24 arranged at intervals, and the second connecting rod 42 is provided with two; the first ends 421 of the two second connecting rods 42 are rotatably connected to the two ends of the first rotating shaft 43 respectively, the second ends 422 of the two second connecting rods 42 are rotatably connected with the first connection end 23 and the second connection end 24 respectively, and the output end 31 of the electric push rod is positioned between the first ends 421 of the two second connecting rods 42.

In this way, in the driving process of the pushing mechanism 30, the pushing mechanism 30 first drives the first rotating shaft 43 to move, and the first rotating shaft 43 drives the two second connecting rods 42 to move. The first ends 421 of the two second connecting rods 42 are rotatably connected to the two ends of the first rotating shaft 43, respectively, so that the transmission of the two second connecting rods 42 is relatively stable.

In some embodiments, two second connecting rods 42 synchronously drive the first connection end 23 and the second connection end 24 of the bracket 20 to move, enabling the bracket 20 to rotate up and down. There are two stress points on which the bracket 20 is pushed, and they are arranged horizontally at intervals, so as to obtain the same push force on both sides of the bracket 20 and ensure the rotational stability of the bracket 20 in the pitch motion and rotation process.

In some embodiments, in order to ensure the transmission stability and installation stability between the first connecting rod 41 and the second connecting rod 42, the second end 412 of the first connecting rod 41 has two loop plates 4121 arranged oppositely, the two loop plates 4121 are rotatably connected with the first rotating shaft 43, the first end 421 of the second connecting rod 42 is positioned between the two loop plates 4121, and the two loop plates 4121 can restrict the first end 421 of the second connecting rod 42 from sliding on the first rotating shaft 43 along an axial direction of the first rotating shaft 43.

In this way, the second connecting rod 42 is limited by the two loop plates 4121, and it is not easy to be separated from the first rotating shaft 43.

In some further embodiments, the connection between one of the first connecting rod 41 and the corresponding second connecting rod 42 may be the same as that of the above-mentioned embodiment. Another second connecting rod 42 and another second connecting rod 42 may be arranged at intervals to save the overall occupied space of the linkage mechanism 40 and facilitate the layout of other electrical components in the robot body 10.

In further embodiments, the connecting rods between two first connecting rods 41 and the two corresponding second connecting rods 42 can be arranged according to the above embodiments.

In order to improve the structural stability of the bracket 20 when the electric push rod is in the extended limit state to enable the actuator mechanism 110 to be stable in a predetermined state (predetermined angle and/or predetermined height). In some embodiments, the bracket 20 is provided with a first limit surface 211, and when the electric push rod is extended to the extended limit position, the first limit surface 211 can limit the rotation of the second connecting rod 42. It can be understood that the second connecting rod 42 may be provided with a corresponding first limiting structure to cooperate with the first limit surface 211 in a limiting manner.

For example, the second connecting rod 42 may have a front face facing the bracket 20, the front face is a first limit structure. When the electric push rod is in the extended limit state, the first limit surface 211 cooperates with the front face of the second connecting rod 42 in a limiting manner.

For another example, the second connecting rod 42 may have a front face facing the bracket 20 and a side face adjacent to the front face, and the side face forms a limit step, the limit step is a first limit structure. When the electric push rod is in the extended limit state, the first limit surface 211 cooperates with the step face of the limit step in a limiting manner.

In this embodiment, when there are two second connecting rods 42, the limit structure of one second connecting rod 42 is designed as its front face, and the limit structure of the other second connecting rod 42 is designed as its limit step of the side face. In this way, the two connecting rods respectively cooperate with the bracket 20 in a limiting manner, so that there are a plurality of limiting positions between the bracket 20 and the linkage mechanism 40, which further improves the structural stability of the bracket 20 when the electric push rod is in an extended limit state.

In order to improve the structural stability of the bracket 20 when the electric push rod is in the retracted limit state to enable the actuator mechanism 110 to be stable in the predetermined state (predetermined angle and/or predetermined height). In some embodiments, the bracket 20 is provided with a second limit surface 212, and when the electric push rod is retracted to the limit position, the second limit surface 212 can limit the rotation of the second connecting rod 42. It can be understood that the second connecting rod 42 may be provided with a corresponding second limiting structure to cooperate with the second limit surface 212 in a limiting manner.

For example, the second connecting rod 42 may have a front face facing the bracket 20 and a back face opposite to the front face, and the back face constitutes the second limit structure. When the electric push rod is in the retracted limit state, the second limit surface 212 cooperates with the back face of the second connecting rod 42.

In some embodiments, there may be two second connecting rods 42, the front face of one second connecting rod 42 is its first limit structure and the back face is its second limit structure, and the side face of the other second connecting rod 42 has a limit step, and the limit step is its first limit structure.

In order to reduce the driving strength of the electric push rod during the extension process and save the energy consumption of the electric push rod, the second end of the second connecting rod 42 is rotatably connected with the top of the bracket 20.

It can be understood that the bottom of the bracket 20 is rotatably connected with the bottom plate 14 of the robot body 10, so that when the bracket 20 rotate up and down, it makes a circular motion around its rotating connection position (i.e., fulcrum). That is, the farther away the second end of the second connecting rod 42 is from the bottom of the bracket 20 (i.e., the longer the arm of force), the smaller the push force of the second connecting rod 42 to drive the bracket 20 to rotate (i.e., the smaller the required force), and the less the energy consumption of the electric push rod.

Therefore, the second end of the second connecting rod 42 is rotatably connected with the top of the bracket 20, so that the energy consumption of the electric push rod can be reduced as much as possible.

In order to facilitate the installation of the bracket 20, the bottom plate 14 of the robot body 10 is provided with a rotatable third rotating shaft 15, and the bottom of the bracket 20 is provided with the third rotating shaft 15.

Referring to FIG. 4, in order to further improve the support stability of the electric push rod and linkage mechanism 40 to the bracket 20 when the electric push rod is in the extended limit position, when the electric push rod is extended to the extended limit position, the center lines of the first connecting rod 41 and the second connecting rod 42 are coplanar and form an acute angle with the bracket 20. It can be understood that the first connecting rod 41 and the second connecting rod 42 are collinear to form an acute angle with the bracket 20. The stability of the triangle is employed to improve the supporting stability of the bracket 20.

Specifically, when the electric push rod extends to the limit position, the bracket 20 is perpendicular to the bottom plate 14 of the robot body 10.

In addition, in order to facilitate the disassembly and assembly of the bracket 20 and the actuator mechanism 110 and the replacement of different actuator mechanisms 110, the side of the bracket 20 facing away from the pushing mechanism 30 is provided with an installation part 22. The installation part 22 is used for detachable assembly with the actuator mechanism 110.

The installation part 22 may be a detachable structure in the prior art, such as bolt assembly, screw assembly and the like.

In this embodiment, in order to reduce the assembly difficulty and improve the user experience, the installation part 22 is a hook, so that when the user dismounts the actuator mechanism 110 or replaces a different actuator mechanism 110, the assembly and disassembly can be realized by hooking or contacting the hook. The operation is simple without additional auxiliary tools.

In some embodiments, in order to improve the assembly stability of the bracket 20 and the actuator mechanism 110, the bracket 20 has two columns 21 arranged oppositely, the lower ends of the two columns 21 are respectively installed on the two ends of the third rotating shaft 15, and the two columns 21 are both provided with the installation part 22.

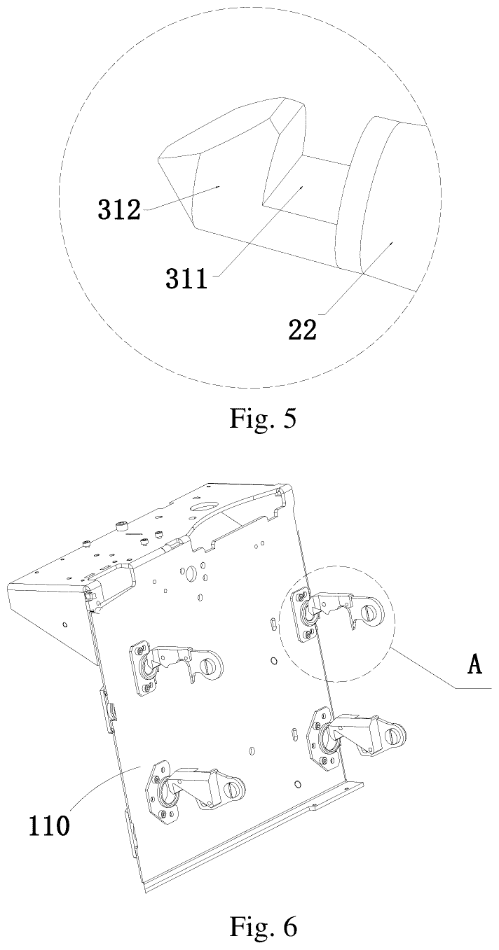

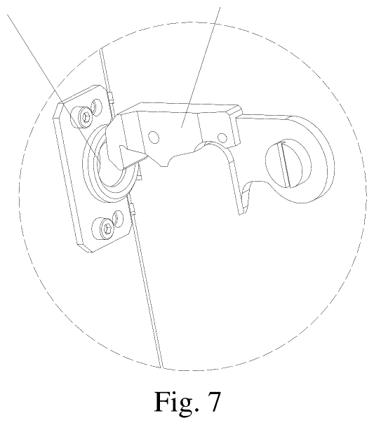

Referring to FIGS. 5 to 7, in some embodiments, the actuator mechanism 110 includes a machine body provided with an insertion hole 321, and the actuator mechanism 110 includes a buckle 322 positioned in the machine body, and the buckle 322 is arranged near an open end of the insertion hole 321; the installation part 22 includes an insertion column 312, and a clamping groove 311 is arranged on the insertion column 312, and the insertion column 312 is able to be inserted into the insertion hole 321 so that the insertion hole 321 is able to be clamped in the clamping groove 311. The hole wall of the insertion hole 321 has the function of guiding and positioning the insertion column 312, and the buckle 322 is rotatably connected with the actuator mechanism 110.

In some embodiments, the buckle 322 is rotatably arranged on the machine body, and has a locking position that can be clamped with the insertion column 312 and an unlocking position that is separated from the insertion column 312 when rotating. The machine body can be provided with a manual part which is drivingly connected with the buckle 322 through the corresponding linkage mechanism. When the user manually drives the manual part, the buckle 322 can rotate to the unlocking position. In this state, the insertion column 312 is completely inserted into the insertion hole 321, and then the manual part is released. Under the action of elastic members such as tension springs, the buckle 322 can automatically rotate to the locking position, thus completing the clamping between the buckle 322 and the clamping groove 311. When disassembly is required, manually driving the manual part can enable the buckle 322 to rotate to the unlocking position, allowing the buckle 322 to move around to avoid the insertion column 312, then the insertion column 312 is removed.

In order to enhance the stability and reliability of the connection, a plurality of installation parts 22, insertion holes 321 and buckles 322 are provided, and the insertion holes 321 and buckles 322 correspond to each other one by one, and the installation parts 22 and insertion holes 321 correspond to each other one by one.

The actuator mechanism 110 is one of a snow removal mechanism, a mowing mechanism and an air blowing mechanism.

In some embodiments, in order to improve the user experience and practicality, the actuator mechanism 110 is driven by the pushing mechanism 30 to pitch up and down, with a pitch angle between 0° and 25°.

For the description of the present application, it should be noted that unless otherwise specified and defined, the terms “installation” and “connected” should be understood in a broad sense. For example, it may be a fixed connection, a detachable connection, an integral connection or a transmission connection. It can be directly connected or indirectly connected through an intermediate medium. For those of ordinary skill in the art, the specific meanings of the above terms in the present application may be understood in specific situations.

Furthermore, the terms “first” and “second” are merely used to differentiate descriptions and shall not be interpreted as particular or special structures. The phrase “some embodiments” refers to the specific features, structures, materials, or features described by the embodiments or examples, which are included in the embodiments or examples of the application. In this specification, the illustrative expressions of the above terms do not necessarily refer to the same embodiment or example. Furthermore, the specific features, structures, materials, or characteristics described may be combined in any one or more embodiments or examples in an appropriate manner. In addition, without contradicting one another, those skilled in the art may combine various embodiments, examples, and features of various embodiments, examples, and examples described in this specification.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and shall be included in the protection scope of this application.

I/We claim:

1. A working robot, comprising:
an actuator mechanism; and
a mobile robot, wherein the mobile robot comprises:
a robot body;
a bracket pivotably mounted on the robot body, wherein the actuator mechanism is detachably mounted on the bracket;
a pushing mechanism mounted within the robot body, wherein the pushing mechanism comprises a linear drive element having an output end; and
a linkage mechanism disposed between the pushing mechanism and the bracket, wherein:
the linkage mechanism comprises a first connecting rod and a second connecting rod,
the first connecting rod has a first end rotatably mounted on the robot body and a second end rotatably connected to the output end,
the second connecting rod has a first end rotatably connected to the output end of the linear drive element and a second end rotatably connected to the bracket, and
the pushing mechanism is drivingly connected to the bracket via the linkage mechanism to drive the bracket to rotate, thereby causing the actuator mechanism to perform a pitching movement relative to the mobile robot.

2. The working robot of claim 1, wherein:
the robot body comprises a housing and a support beam,
the housing has two side plates arranged opposite to each other,
each of the two side plates has a through hole,
the support beam extends through the through holes of the two side plates, and
the pushing mechanism is mounted on the support beam.

3. The working robot of claim 2, wherein the pushing mechanism is rotatably mounted on the support beam.

4. The working robot of claim 1, wherein:
the linkage mechanism comprises a first rotating shaft rotatably mounted on the output end of the linear drive element,
the second end of the first connecting rod is rotatably connected to the first rotating shaft, and
the first end of the second connecting rod is rotatably connected to the first rotating shaft.

5. The working robot of claim 4, wherein:
the bracket has a first connection end and a second connection end spaced apart from each other,
the linkage mechanism comprises two second connecting rods,
the first ends of the two second connecting rods are rotatably connected to the first rotating shaft respectively,
the output end of the linear drive element is positioned between the first ends of the two second connecting rods, and
the second ends of the two second connecting rods are rotatably connected to the first connection end and the second connection end, respectively.

6. The working robot of claim 4, wherein:
the second end of the first connecting rod comprises two loop plates arranged opposite to each other,
the two loop plates rotatably receive the first rotating shaft,
the first end of the second connecting rod is positioned between the two loop plates, and
the two loop plates are configured to restrict the first end of the second connecting rod from sliding along an axial direction of the first rotating shaft on the first rotating shaft.

7. The working robot of claim 1, wherein:
the bracket comprises a first limit surface configured to restrict rotation of the second connecting rod when the linear drive element extends to a first limit position.

8. The working robot of claim 1, wherein:
the bracket comprises a second limit surface configured to restrict rotation of the second connecting rod when the linear drive element retracts to a second limit position.

9. The working robot of claim 1, wherein:
a bottom portion of the bracket is rotatably connected to the robot body, and
the second end of the second connecting rod is rotatably connected to a top portion of the bracket.

10. The working robot of claim 9, wherein:
the robot body is provided with a rotatable third rotating shaft, and
the bottom portion of the bracket is mounted on the third rotating shaft.

11. The working robot of claim 1, wherein:
the linkage mechanism comprises a second rotating shaft rotatably mounted on the robot body, and
the first end of the first connecting rod is rotatably connected to the second rotating shaft.

12. The working robot of claim 1, wherein:
the first end of the first connecting rod is rotatably mounted on a bottom plate of the robot body, and
when the linear drive element extends to an extension limit position, center lines of the first connecting rod and the second connecting rod are coplanar and form an acute angle with the bottom plate of the robot body.

13. The working robot of claim 1, wherein:
an installation part mounted on a side of the bracket facing away from the pushing mechanism, and
the installation part is configured for detachable assembly with the actuator mechanism.

14. The working robot of claim 13, wherein:
the bracket comprises two columns disposed opposite to each other,
lower ends of the two columns are rotatably mounted on a third rotating shaft, and
the two columns are both provided with the installation part.

15. The working robot of claim 14, wherein:
the first end of the first connecting rod is rotatably mounted on a bottom plate of the robot body, and
when the linear drive element extends to an extension limit position, the two columns of the bracket are perpendicular to the bottom plate of the robot body.

16. The working robot of claim 14, wherein:
the actuator mechanism comprises a body defining an insertion hole and a buckle rotatably arranged on the body adjacent to the insertion hole,
the installation part comprises an insertion column defining a clamping groove, and
the insertion column is configured to be inserted into the insertion hole such that the buckle releasably engages the clamping groove.

17. The working robot of claim 1, wherein:
the actuator mechanism is configured to perform the pitching movement within a pitch angle range of 0° and 25°.

18. The working robot of claim 1, wherein:
the actuator mechanism comprises one selected from a snow removal mechanism, a mowing mechanism, or a blowing mechanism.

19. A method of operating a working robot,
the working robot comprising a mobile robot and an actuator mechanism detachably mounted on a bracket of the mobile robot, and
the method comprising:
activating a linear drive element of a pushing mechanism mounted within a robot body of the mobile robot to extend or retract an output end;
transmitting a driving force from the output end to the bracket via a linkage mechanism comprising a first connecting rod and a second connecting rod, wherein:
a first end of the first connecting rod is rotatably mounted on a bottom plate of the robot body and a second end of the first connecting rod is rotatably connected to the output end, and
a first end of the second connecting rod is rotatably connected to the output end and a second end of the second connecting rod is rotatably connected to the bracket; and
rotating the bracket relative to the robot body to adjust a pitch angle of the actuator mechanism relative to the mobile robot.

20. A method of reconfiguring a working robot,
the working robot comprising:
a mobile robot having a robot body with a bottom plate,
a bracket pivotably mounted on the robot body, and
a pushing mechanism mounted within the robot body comprising a linear drive element drivingly connected to the bracket via a linkage mechanism comprising a first connecting rod and a second connecting rod, wherein:
a first end of the first connecting rod is rotatably mounted on the bottom plate,
a second end of the first connecting rod is rotatably connected to an output end of the linear drive element,
a first end of the second connecting rod is rotatably connected to the output end, and
a second end of the second connecting rod is rotatably connected to the bracket, and
the method comprising:
detaching a first actuator mechanism from an installation part of the bracket; and
attaching a second actuator mechanism to the installation part of the bracket.
